(19) United States
(12) Patent Application Publication
(10) Pub. No.: US 2014/0101671 A1
(43) Pub. Date: Apr. 10, 2014

(54) INFORMATION PROCESSING APPARATUS AND INFORMATION PROCESSING METHOD

(71) Applicant: CANON KABUSHIKI KAISHA, Tokyo (JP)

(72) Inventor: Hidenori Kobayashi, Tokyo (JP)

(73) Assignee: CANON KABUSHIKI KAISHA, Tokyo (JP)

(21) Appl. No.: 14/045,525

(22) Filed: Oct. 3, 2013

(30) Foreign Application Priority Data
Oct. 9, 2012 (JP) 2012-224237

(51) Int. Cl. G06F 9/50

(52) U.S. Cl. CPC G06F 9/505
USPC 718/105

(57) ABSTRACT

On a multiprocessor, a task may move between processors, and a context of the processor and a context of a co processor are together transferred at the time of a task switch, resulting in a reduced execution efficiency. The movement between the processors of the task using the co processor is restricted, to reduce the number of times of transfer of the co processor context.

### BACKGROUND

1. Technical Field

Aspects of the present invention relate to an information processing apparatus for managing a context, and an information processing method.

2. Description of the Related Art

A subsidiary processing apparatus for implementing processing for functionally expanding or assisting a processor includes a co processor. A co processor, to which at least one of a floating-point operation, a vector operation, image processing, debug mechanism control, and a system control function is allocated, may be mounted on a processor, for example, in addition to a processor core for implementing basic processing.

Each co processor is associated with a register. Each of a setting value retained in the register and an intermediate value of the register used for an operation of the co processor is referred to as a co processor context, and is distinguished from a context retained in a register that is associated with a processor core. The co processor context may be managed for each task. If the same floating point number processing unit is used to process a plurality of tasks, for example, a co processor context of the floating point number processing unit is desirably managed for each of the tasks.

Thus, an operating system generally manages the co processor context for each of the tasks. In a simple management method, the co processor context for the task that has been so far executed is temporarily retracted from the register to a memory, and the co processor context for the task to be then executed is restored from the memory to the register within the processor at the time of a task switch. Such an operation is referred to as a context switch (or preemption).

However, the context switch of the co processor need not necessarily be performed for each task switch. Therefore, Japanese Patent Application Laid-Open No. 3-94362 discusses a method for invalidating a co processor at the time of a task switch and validating the co processor and switching a co processor context at the time of an exception notification by accessing the co processor.

However, if the method discussed in Japanese Patent Application Laid-Open No. 3-94362 is performed in a configuration in which a processor is reallocated to a task, for example, a co processor other than a co processor associated with a co processor context for a task may be allocated to operation processing for the co processor of the task. Generally, an access to a co processor from outside a processor to which the co processor belongs is larger in latency than an access from inside the processor. More specifically, even if a processor that attempts to execute a task accesses the co processor by moving a co processor context to a shared memory, the processing efficiency of a system may be reduced by only a period of time required to move the co processor context to the shard memory.

### SUMMARY

According to an aspect of the present invention, an information processing apparatus including a multiprocessor including a plurality of processors each including a first processing unit configured to process an allocated task based on a content of a first register, and a second processing unit configured to process the task based on a content of a second register includes a transfer unit configured to focus on one of the processors included in the multiprocessor, and to transfer, if a task to be allocated to the focused processor is changed, respective contents retained in a first register in the focused processor and a second register in the focused processor to a memory, and a control unit configured to, in response to the fact that a task allocated to the focused processor is started to be processed by a second processing unit in the focused processor, perform control to prohibit the transfer unit from transferring the content retained in the second register corresponding to the second processing unit to the memory.

Further features and aspects of the present invention will become apparent from the following description of exemplary embodiments with reference to the attached drawings.

### BRIEF DESCRIPTION OF THE DRAWINGS

FIG. 1 is a block diagram illustrating an entire configuration of an information processing apparatus.

FIG. 2 is a block diagram illustrating an outline of a system configuration.

FIG. 3 is a flowchart illustrating processing at the time of a task switch.

FIG. 4 is a flowchart illustrating processing at the end of a task.

FIG. 5 is a flowchart illustrating processing at the time of a floating point number processing unit (FPU) exception.

FIG. 6 is a conceptual diagram illustrating an example of scheduling in a conventional technique.

FIG. 7 is a conceptual diagram illustrating an example of scheduling according to the present invention.

FIG. 8 is a flowchart illustrating processing of a system call FPStart.

FIG. 9 is a flowchart illustrating processing of a system call FPFinish.

FIG. 10 illustrates an example of a task program by a pseudo code using a system call.

FIG. 11 is a conceptual diagram illustrating an example of scheduling according to the present invention.

FIG. 12 is a flowchart illustrating a schematic operation of an information processing apparatus 100.

FIG. 13A is a schematic view of an FPU control block.

FIG. 13B is a schematic view of processor allocation information.

FIG. 13C is a schematic view of a main context and a sub-context that are retracted for each task.

### DESCRIPTION OF THE EMBODIMENTS

A first exemplary embodiment will be described.

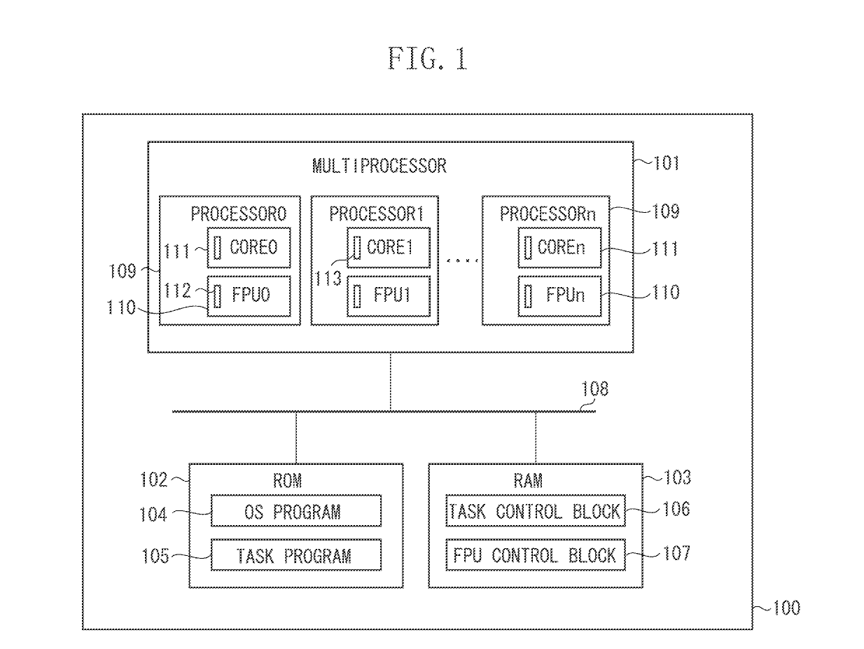

FIG. 1 illustrates a schematic configuration of an information processing apparatus 100 according to a first exemplary embodiment of the present invention. A multiprocessor 101 includes a plurality (n; an integer of 2 or more) of processors 109 each including a processor core (a first processing unit, i.e., a main processing unit) 111 and a floating point number processing unit (FPU) 110 serving as a co processor (a second processing unit, i.e., a sub-processing unit). Each of the processor core 111 and the FPU 110 includes a decoder logic and an operation circuit. The FPU 110 can perform addition, subtraction, multiplication and division, a product-sum operation, and a square-root operation in single-precision and double-precision floating-point formats, and is smaller in die size, number of gates, and average power consumption than the processor core 111. The FPU 110 supports a floating-point exception (an invalid operation, division by zero, overflow, underflow, inaccuracy) defined by IEEE 754 (IEEE: The Institute of Electrical and Electronics Engineers, IEEE 754 is a floating-point number operation standard).

In the present exemplary embodiment, the FPU 110 has its invalid/valid state controlled by the processor core 111 in the processor 109 to which itself belongs. If the FPU 110 is in an invalid state, for example, a clock to be supplied to the FPU 110 is reduced, a voltage to be supplied to the FPU 110 is reduced, and setting to ignore an operation command to the FPU 110 is performed. Thus, the FPU 110 does not receive and process the operation command until it is switched to a valid state. If an attempt to use a function of the FPU 110 is made when the FPU 110 is in an invalid state, the FPU 110 needs to be reset to a valid state where it can be used. When a floating-point operation command is issued to the FPU 110 in an invalid state, for example, the FPU 110 notifies the processor core 111 in the processor 109 to which itself belongs of an exception. The processor core 111, which has received the notification, switches the FPU 110, which has notified of the exception, to a valid state. A detailed situation where a valid state and an invalid state are switched will be described below.

Each of the processor cores 111 can access a read only memory (ROM) 102 and a random access memory (RAM) 103 via a bus 108. An OS program 104 and a task program 105 are retained in the ROM 102 at the time of product shipment. The information processing apparatus 100 decompresses compressed data retained in the ROM 102 or a hard disk drive (HDD) by the multiprocessor 101 at the time of startup, arranges a program (the OS program 104 and the task program 105) for implementing processing, described below, on the RAM 103, and ensures an area for retaining a task control block 106 and an FPU control block 107 on the RAM 103. An operating system (hereinafter referred to as an OS) is implemented when at least one of the processor cores 111 executes a binary code belonging to the OS program 104. Microscopically, the processor core 111 executes the binary code belonging to the OS program 104 and a binary code belonging to the task program 105 in a time-divisional manner, but macroscopically, the OS is considered to be also in a startup state while the task program 105 is being executed.

Each of the processors 109 includes a register set 112 (a second register) and a register set 113 (a first register) to retain a context. The register set 113 includes a plurality of 32-bit registers. The plurality of registers includes a general-purpose register, a program counter (storing a value that is incremented by one word for each command), and a status register (storing a copy of a status flag of a logic operation device, a current processor mode, and an interrupt invalidation flag).

The register set 112 includes 16 64-bit registers. The 16 registers include at least a plurality of FPU general-purpose registers capable of respectively retaining a single-precision floating point value and a 64-bit integer, and an FPU system register for retaining a mode of the FPU 110 (a user access and a privilege access).

As illustrated in FIG. 1, a register group (generally, floating-point registers, etc.) associated with the FPU 110 and mainly used by the FPU 110 and a register group (general-purpose registers, etc.) associated with the processor core 111 and mainly used by the processor core 111 in the register sets 112 and 113 are distinguished. The processor core 111 in the processor 109 can directly access (copy and write a read content into its own registers, and performing operation using read content) the register set 112 in the FPU 110 in the same processor 109. Similarly, the FPU 110 can also directly access the register set 113 in the processor core 111 in the same processor 109.

A context retained in the register set 112 or the register set 113 is a data structure including a setting value (a content of a program counter, a status of a process, a value representing a status or a setting of a pointer, and information specific to an OS) and an intermediate value (a value to be accessed by the task program 105, an intermediate processing result, and a condition code). In the following description, a context for a task to be executed by the processor core 111 is referred to as a main context, and a context for a task to be executed by the FPU 110 is referred to as a sub-context (or an FPU context).

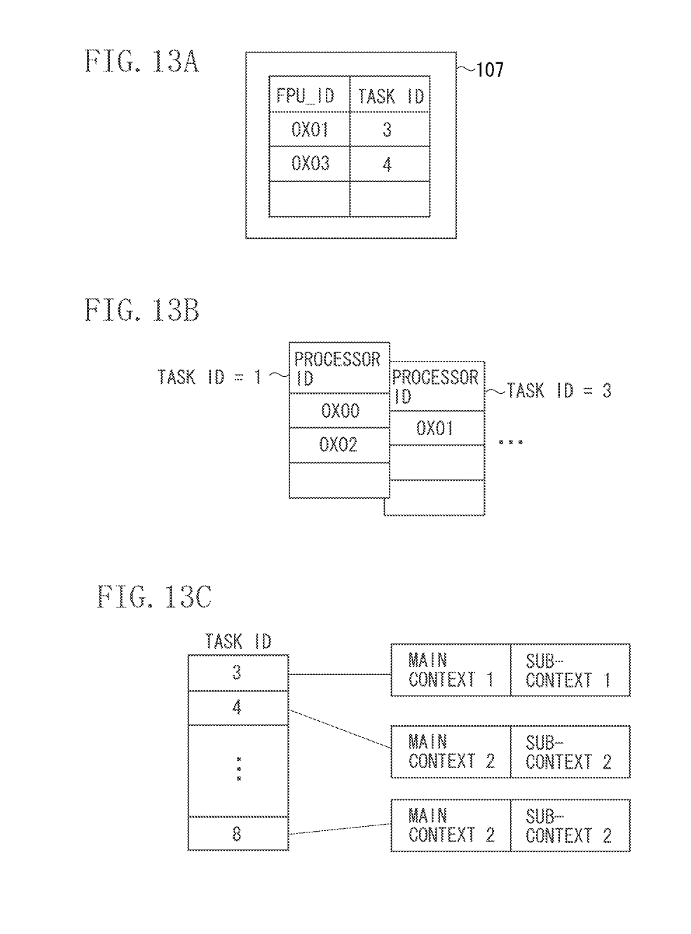

The task control block 106 includes processor allocation information for retaining identification information of a processor to or from which a task can be allocated or moved (see FIG. 13B), a retracted main context, and a retracted sub-context (see FIG. 13C). The FPU context may be provided not within the task control block 106 but a stack area for each task. The FPU control block 107 retains FPU use task identification information (see FIG. 13A) for identifying a task during use of the FPU 110 (a task that is being processed by the FPU 110). Details of FIGS. 13A to 13C will be described below.

In the present exemplary embodiment, the FPU 110 is brought into an invalid state at the time of startup so that the FPU 110 starting processing is detected by an FPU exception. An OS, described below, is responsive to the detection for registering identification information of a task during use of the FPU 110 in the FPU control block 107 by associating the identification information with identification information of the FPU 110. Thus, at the time of a switch (a change) from the task using the FPU 110 to a task not using the FPU 110, the FPU context can be prevented from being transferred.

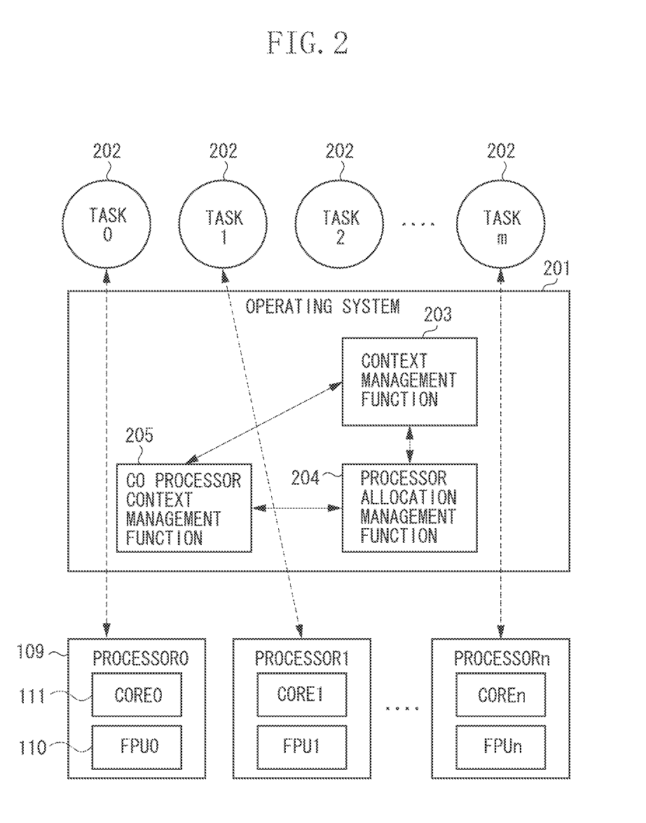

FIG. 2 is a schematic view of a functional configuration of an OS 201 according to the present exemplary embodiment. m tasks 202 are a plurality of program units included in the task program 105, described above. The OS 201 allocates the print waiting tasks 202, respectively, to the processors 109 in descending order of priorities. The OS 201 refers to “a correspondence between the type of task and the priority” previously stored, and determines a priority of each of the tasks 202.

The OS 201 is executed by at least one of the processors 109, to implement a context management function 203, a processor allocation management function 204, and a co processor context management function 205 (The functions are obtained by classifying and abstracting functions of the OS 201 for ease of understanding. Details for implementing each of the functions will be described below).

Each of the plurality of processors 109 desirably executes a binary code for implementing the OS 201. The processor core 111 in each of the processors 109 executes a code of the OS 201 in an interval of task processing, and implements the context management function 203, the processor allocation management function 204, and the co processor context management function 205. The processor allocation management function 204 is a general scheduler. Timing at which the scheduler is started includes the time when a status of a queue (not illustrated) of the processor core 111 has been changed, the time when prohibition of scheduling has been cancelled, and the time when the processor core 111 has returned from the interruption processing. Each of the processors 109 can also independently operate the scheduler. Alternatively, a scheduler for a processor 0 can also issue an interprocessor interrupt to processors 1 and 3 to start respective schedulers for the processors 1 and 3.

In the example illustrated in FIG. 2, the OS 201 allocates a task 0, a task 1, and a task m, respectively, to the processor 0, the processor 1, and a processor n.

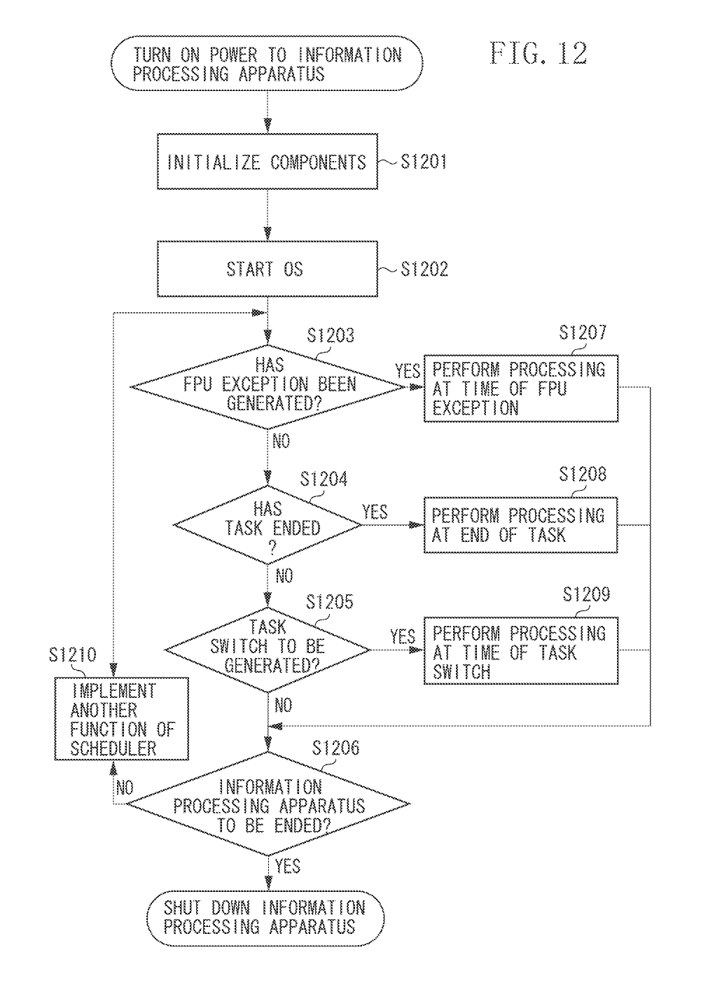

A schematic operation of the information processing apparatus 100 will be described below with reference to a flowchart illustrated in FIG. 12.

If power to the information processing apparatus 100 is turned on, then in step S1201, each of the components of the information processing apparatus 100 is initialized at a hardware level. At this time point, the binary code of the OS program 104 is transferred from a nonvolatile storage medium such as the ROM 102 or the HDD to the RAM 103 serving as a volatile medium. The processor core 111 and the FPU 110 are initialized. Further, each of the FPUs 110 is set to an invalid state. When the processor core 111 and the FPU 110 are initialized, the register set 112 and the register set 113 are also initialized.

In step S1202, the processor 109 in the multiprocessor 101 executes the binary code of the OS program 104, which has been transferred to the RAM 103, to start the OS 201. Further, areas for respectively retaining the task control block 106 and the FPU control block 107 are ensured on the RAM 103 by the multiprocessor 101 executing the OS program 104. The binary code of the task program 105 is then transferred from a nonvolatile storage medium such as the ROM 102 or the HDD to the RAM 103 serving as a volatile medium.

The OS 201 allocates the plurality of tasks 202 as scheduling targets, respectively, to the processors 109 in the multiprocessor 101.

In step S1203, the processor core 111 in the multiprocessor 101 then determines whether an FPU exception has been generated. A task switch is generated by an interrupt from a timer (not illustrated) and a notification from a scheduler.

If the FPU exception has been generated (YES in step S1203), then in step S1207, the co processor context management function 205 performs “processing at the time of an FPU exception”, described below.

If the FPU exception has not been generated (NO in step S1203), then in step S1204, the multiprocessor 101 determines whether the task 202 allocated to the processor 109 has ended. The determination whether the task 202 has ended can autonomously be performed depending on whether the processor core 111 that is executing the task 202 has processed the task 202 during execution to its final command.

If the task 202 has ended (YES in step S1204), then in step S1208, the co processor context management function 205 performs “processing at the end of a task”, described below.

If the task 202 has not ended (NO in step S1204), then in step S1205, the processor allocation management function 204 to be implemented by the multiprocessor 101 determines whether a task switch is to be generated.

The determination whether a task switch is to be generated may be performed by an interrupt from a timer (not illustrated), blocking of the task 202 during execution, and the presence or absence of a task switch instruction from a user or an application. The blocking of the task 202 means a state where processing of the task 202 cannot be advanced due to input-output (I/O) waiting of the task 202, synchronization between the tasks 202, and message receiving waiting between the tasks 202.

If a task switch is to be generated (YES in step S1205), then in step S1209, the co processor context management function 205 performs “processing at the time of a task switch”, described below.

If the task switch is not generated (NO in step S1205), then in step S1206, the multiprocessor 101 determines whether the information processing apparatus 100 has ended. Under the condition that the information processing apparatus 100 is set to be shut down in response to completion of processing of all the tasks, other than the OS 201, out of the tasks that are being executed in the multiprocessor 101, for example, if the tasks other than the OS 201 are completed or a forcible shutdown instruction from the user is received (YES in step S1206), the information processing apparatus 100 is shut down.

If the information processing apparatus 100 should not end (NO in step S1206), then in step S1210, the OS 201 implements another function of the scheduler. If a new task is generated, for example, the new task is allocated to the processor 109, like in step S1202.

In FIG. 12, steps S1202 to S1210 are desirably processed independently by each of the processors 109 in parallel. At this time, each of the processors 109 performs the processing by considering own processor as a focused processor. Steps S1203 to S1205 (steps S1207 to S1210) are in a parallel relationship, and may be processed in any order.

### Task Allocation

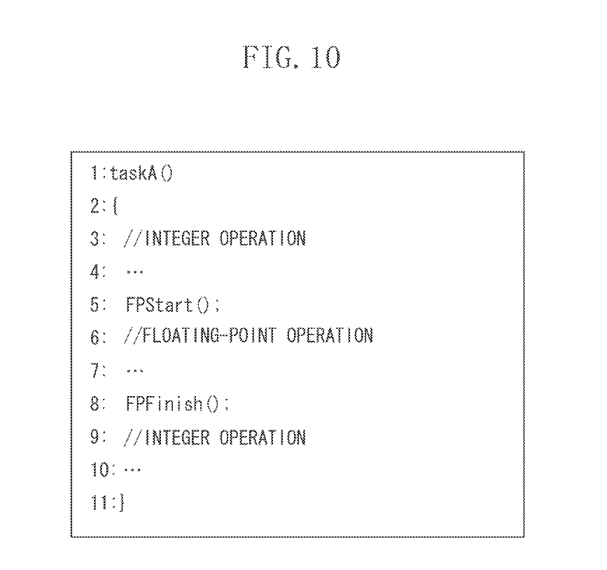

Processing for allocating the task 202 by the processor allocation management function 204 in the OS 201 in steps S1202 and S1210 will be described in detail below. The plurality of tasks 202 is a mixture of a task including a floating-point operation command using the FPU 110 (see FIG. 10) and a task including no floating-point operation command. The processor allocation management function 204 allocates the task 202 in a ready state (an executable waiting state) to the processor 109 using a method referred to as “Fixed-priority pre-emptive scheduling”.

The context management function 203 manages a context of the processor core 111 on the task control block 106 for each task, and the processor allocation management function 204 determines the processors 109 to which the tasks 202-0 to 202-m are respectively allocated based on priorities determined from information previously set. When the context management function 203 allocates a task A illustrated in FIG. 10 to the processor 0, for example, the processor core 0 in the processor 0 interprets a binary code of the task A, and transfers the binary code in a predetermined unit to the processor core 0 in the processor 0 from the RAM 103 in response to a transfer command. If a command read into the processor core 0 using a fetch logic or a decoder logic of the processor core 0 includes a floating-point operation command, the processor core 0 transfers a command for an FPU including a floating-point operation command to an FPU 0, and causes the FPU 0 to process the command.

The FPU 0 stores a floating-point operation result in the register set 112, and the FPU 0 or the processor core 0 transfers the floating-point operation result in the register set 112 to the register set 113. If processing using the floating-point operation result retained in the register set 113 remains in the processor core 0, the processor core 0 further performs processing. If the processing does not remain in the processor core 0, the processor core 0 outputs the floating-point operation result to the RAM 103.

The context management function 203 associates identification information of the task 202 (a task ID) that has been determined to be allocated by the processor allocation management function 204 and identification information of the processor 109 (a processor ID) at an allocation destination, and causes the task control block 106 to retain the associated identification information. The context management function 203 updates processor allocation information in the task control block 106. In a stage where a task switch has not been generated only once from the start of the information processing apparatus 100, the main context and the FPU context have not been retracted to the task control block 106.

The co processor context management function 205 associates the identification information of the task 202 that has been determined to be allocated by the processor allocation management function 204 and identification information of the FPU 110 (FPU_ID) at the allocation destination, and causes the FPU control block 107 to retain the associated identification information.

### Processing at Time of FPU Exception

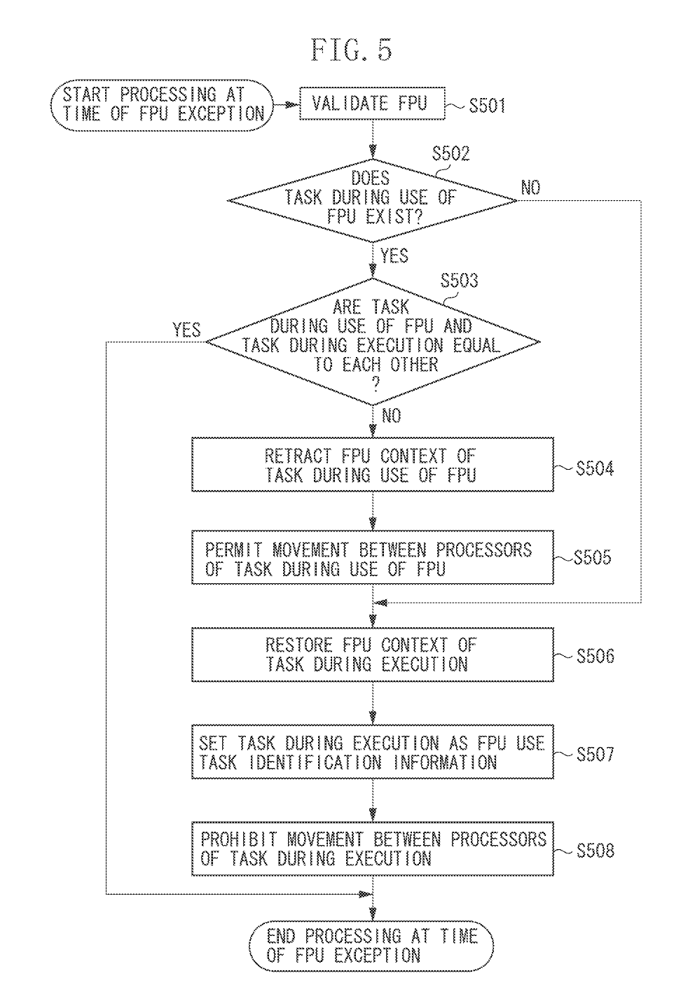

Processing at the time of the FPU exception in the OS 201 in step S1207 will be described in detail below. FIG. 5 is a flowchart illustrating an operation at the time of the FPU exception by the co processor context management function 205 performed when the exception notification from the FPU 110 is used. In a description of the flowchart, an operation of the processor 109 including the FPU 110 that has issued the exception notification is focused on.

In step S501, the processor core 111 belonging to the same processor 109 as that to which the FPU 110, which has issued the exception notification, belongs, first validates the FPU 110 that has issued the exception notification.

In step S502, the co processor context management function 205 refers to the FPU control block 107, and confirms whether the task 202 during use of the FPU 110 that has issued the exception notification exists.

The task during use of the FPU 110 that has issued the exception notification is a task in which an FPU context for the FPU 110 that has issued the exception notification remains in the FPU 110 without being retracted to the task control block 106. Therefore, step S502 corresponds to determination by the processor core 111 belonging to the same processor 109 as that to which the FPU 110, which has issued the exception notification, belongs whether the FPU context for the FPU 110 that has issued the exception notification remains in the register set 112.

If the task 202 during use of the FPU 110 that has issued the exception notification exists (YES in step S502), then in step S503, the co processor context management function 205 confirms whether identification information of the task 202 during use of the FPU 110, which has been confirmed in step S502, and identification information of the task 202 during execution match each other. If the identification information match each other (YES in step S503), the processing ends because the processing may be directly resumed along the FPU context remaining in the register set 112 in the FPU 110 that has issued the exception notification.

On the other hand, if the identification information do not match each other (NO in step S503), then in step S504, the co processor context management function 205 causes the processor core 111 belonging to the same processor 109 as that to which the FPU 110, which has issued the exception notification, belongs, to retract (transfer) the FPU context for the task 202 during use of the FPU 110 that has issued the exception notification to an area for the task 202 within the task control block 106. This tends to be caused by the processor 109 switching the task from a task before the switch (a second task) to a task after the switch (a first task).

In step S505, the co processor context management function 205 permits movement between the processors 109 of the task 202 during use of the FPU 110 that has issued the exception notification (the task 202 that has retracted the FPU context). If the task 202 during use of the FPU 110 does not exist, steps S503 to S505 are not performed.

In step S506, the co processor context management function 205 transfers, as the FPU context for the task 202 during execution, the FPU context, which has been retracted into the task control block 106, to the register set 112 in the FPU 110 to restore the FPU context.

In step S507, the co processor context management function 205 sets the identification information of the task 202 during execution for the processor 109 that has been notified of an exception in the FPU control block 107 as FPU use task identification information.

In step S508, the co processor context management function 205 prohibits the movement between the processors 109 of the task 202 during execution, to end the processing at the time of the FPU exception.

The movement between the processors 109 of the task 202 is permitted and prohibited when the co processor context management function 205 retains only identification information (a processor ID) of the processor 109, which can be allocated, in the task control block 106.

More specifically, if the task 202 is allocated to the processor 109 (reallocated), the task control block is referred to, to determine, out of the processors 109 the identification information of which are registered in the task control block 106, the processor 109 to which the task 202 is allocated. Therefore, the allocation of the task 202 to the processors 109 the identification information of which are not registered in the task control block 106 is restricted, to inhibit movement of the task 202 to the processors 109. If the identification information of all the processors 109 are registered in the task control block 106, the movement of the task 202 between all the processors 109 is also permitted (the inhibition thereof is released).

### Processing at Time of Task Switch

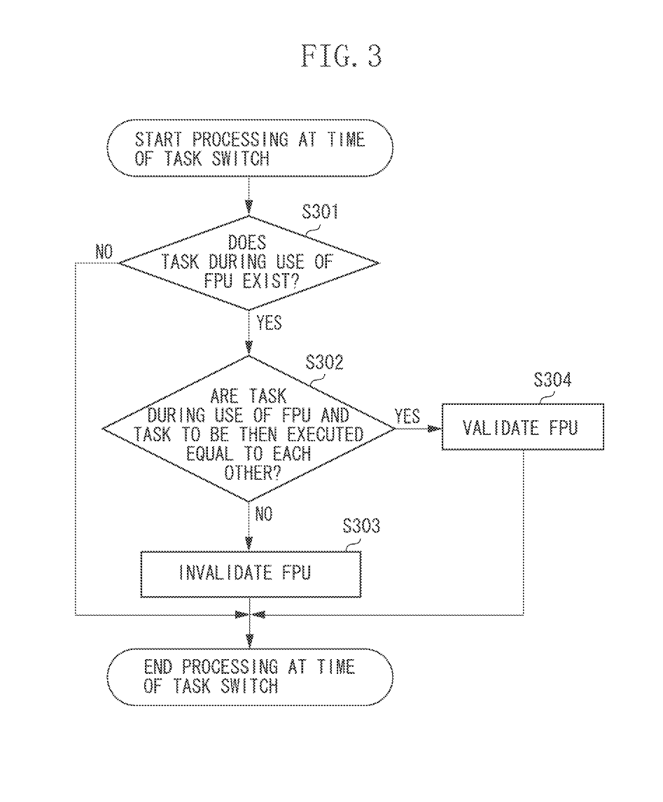

Processing performed when the co processor context management function 205 generates a task switch in step S1207 will be described below with reference to a flowchart illustrated in FIG. 3. Detailed description of a context switch for a main context of a processor core caused by the task switch is omitted.

In step S301, the co processor context management function 205 refers to the FPU control block 107, and confirms whether the task 202 during use of the FPU 110 exists for the processor 109 that generates a task switch. If the task 202 during use of the FPU 110 does not exist (NO in step S301), the processing ends. The task 202 during use of the FPU 110 corresponds to a task in which an FPU context remains in the register set 112 in the processor 109 that generates the task switch.

On the other hand, if the task 202 during use of the FPU 110 exists (YES in step S301), the processing proceeds to step S302. In step S302, the co processor context management function 205 confirms whether identification information of the task 202 during use of FPU 110 and identification information of the task 202 to be then executed (the task 202 to be executed immediately after the task switch) are equal to each other.

If the identification information of the task 202 during use of the FPU 110 and the identification information of the task 202 to be then executed are not equal to each other (NO in step S302), the processing proceeds to step S303. In step S303, the co processor context management function 205 invalidates the FPU 110 in the processor 109 that generates the task switch (a co processor context retained in the invalidated FPU 110 is retracted to a memory by an FPU exception when the other task 202 starts to use the FPU 110). On the other hand, if the identification information are equal to each other (YES in step S302), then in step S304, since the FPU 110 may perform processing including floating-point operation immediately after the task switch, the co processor context management function 205 validates the FPU 110 in the processor 109 that has generated the task switch, and ends the processing at the time of the task switch. If an overhead for confirming the task 202 during use of the FPU 110 is large, for example, control may be performed to always invalidate the FPU 110 once at the time of the task switch. Even in such a case, when a floating-point operation command is actually issued to the FPU 110 in an invalid state, the FPU 110 is set to a valid state by the FPU exception.

### Processing at End of Task

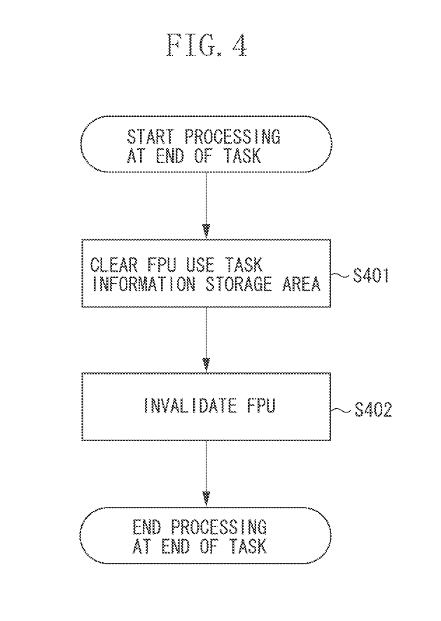

FIG. 4 is a flowchart illustrating processing at the end of the task 202 by the co processor context management function 205. An entry about the task 202 (an FPU use task information storage area) is cleared (discarded) from the FPU control block 107 at the end of the task 202, to invalidate the FPU 110 that has been used by the ended task 202.

In step S401, the co processor context management function 205 clears the FPU use task information storage area about the ended task 202. In step S402, the co processor context management function 205 further invalidates the FPU 110 about the ended task 202, and ends the processing at the end of the task.

### Task Control Block and FPU Control Block

FIG. 13A illustrates FPU use task identification information for identifying the task 202 during use of the FPU 110 (the task 202 that is being processed by the FPU 110). While illustrated in a table for ease of understanding, the FPU use task identification may be a simple data stream if it has a format interpretable by the processor core 111. Other information capable of abstractly pointing out the FPU 110, for example, identification information of the processor 109 may be used as FPU use task identification information.

FIG. 13B illustrates processor allocation information. For each task, identification information of a processor to which the task (can be moved) can be allocated is retained. If processors 1 to n respectively have similar functions, and movement of a task 1 is not restricted, identification information of all the processors 1 to n for the task 1 are retained as the processor allocation information.

FIG. 13C illustrates for each task a retracted main context and a retracted sub-context. The respective numbers of the main context and the sub-context illustrated in FIG. 13C are respectively the number of the processor core 111 and the number of the FPU 110. In this example, a main context 1 of a processor core 1 and a sub-context 1 of an FPU 1 are retained for a task having a task ID 3. For a task having a task ID 4 and a task having a task ID 8, a main context 2 of a processor core 2 and a sub-context 2 of an FPU 2 are retained. If the task IDs differ, processes to be implemented may differ. Therefore, the contexts for the same processor core 111 or the same FPU 110 respectively tend to have different contents.

### Example of Scheduling

Scheduling in the conventional technique and scheduling in the present exemplary embodiment are then compared with each other, to describe handling of an FPU context in the present exemplary embodiment.

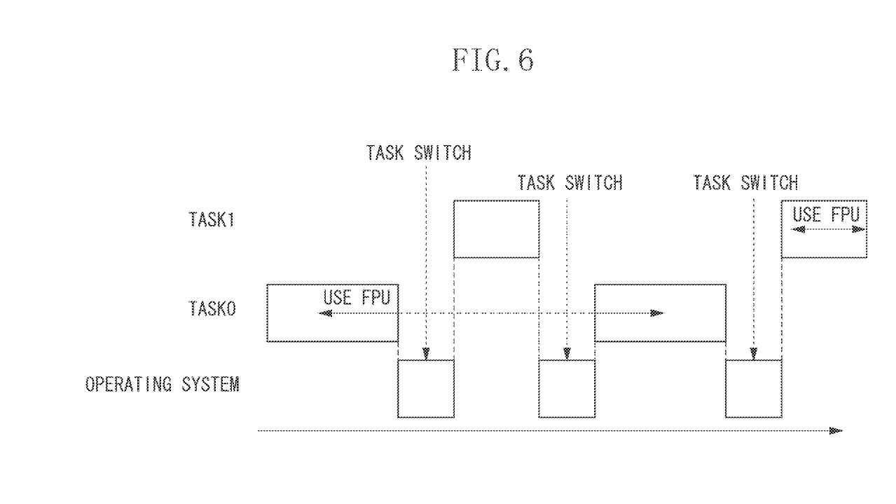

FIG. 6 illustrates how one of the processors 109 in the multiprocessor 101 is focused on, and a plurality of tasks (a task 0 and a task 1) is executed for the focused processor 109. A horizontal axis represents transition of an execution time. In an example illustrated in FIG. 6, the process is started from a task 0, and a task switch is performed three times. An FPU is always in a valid state, and a portion where the FPU is used in the task in the FIG. 6 is indicated by a double-headed arrow. Determination whether the FPU is used may be performed depending on whether a program of the task includes a command to be executed by the FPU.

The scheduling in the conventional example does not consider whether an FPU is used in each task. Every time a task switch is performed, an FPU context, together with a main context, is transferred (retracted and restored). Considering a case where there are 16 8-byte (64-bit) registers as the FPU context, for example, data corresponding to an FPU context composed of a total of 768 bytes is transferred by performing a task switch three times. However, in the example illustrated in FIG. 6, in a period of time elapsed since a task switch from a task 0 to a task 1 was performed until the subsequent task switch is generated, the FPU is not used in the task 1 while the task 0 is in a state where the use of the FPU is interrupted. Therefore, when the task switch from the task 0 to the task 1 is performed, processing for retracting an FPU context for the task 0 becomes useless.

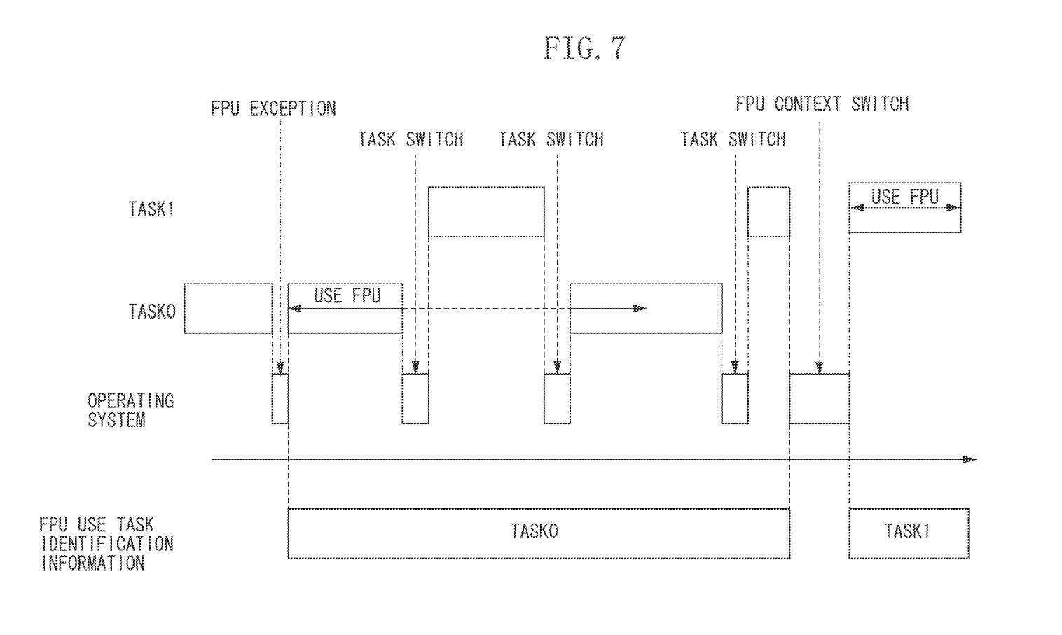

FIG. 7 illustrates an example in which scheduling processing has been performed according to the present exemplary embodiment when two tasks (a task 0 and a task 1) are executed on one of the processors 109 (a first processor) in the multiprocessor 101 (like in FIG. 6). In FIG. 7, a system is started while an FPU is in an invalid state. Therefore, an FPU exception is notified to the processor core 111 at the time point where the task 0 starts to use the FPU.

In the present exemplary embodiment, the start of the use (processing) of the FPU 110 is detected by the FPU execution, to validate the FPU 110 (change the FPU 110 to a valid state). While a task switch is performed three times in FIG. 7, the FPU 110 is set to “invalidated”, “validated”, and “invalidated” in this order. However, in the task switch, an FPU context is not transferred (retracted and restored). Therefore, in the task switch in which the FPU context is neither retracted nor restored, a time required to transfer a content of the FPU context can be reduced.

The FPU context is retracted and restored only at timing of processing at the time of the FPU exception generated when the task 1 performs an FPU c operation after the third task switch is performed. Therefore, considering a case where there are 16 8-byte registers as the FPU context, data corresponding to a 256-byte FPU context may be only transferred in management of the FPU context in the example illustrated in FIG. 7.

As described above, according to the first exemplary embodiment, the number of times of transfer of the FPU context to be transferred for each task switch is reduced, so that an overhead caused by a context switch of a co processor can be reduced.

While the FPU 110 is illustrated as a co processor in the example illustrated in FIG. 1, the co processor in the present invention is not limited to the FPU 110. The co processor may be co processors respectively functioning as a vector operation unit, an image processing unit (e.g., a graphics processing unit), a debug mechanism control unit, an I/O processing device, a memory management unit (MMU), and a direct memory access (DMA) control device. Each of the processors 109 may include a plurality of co processors, or may include co processors having different functions.

While an example in which the task control block 106 retains only an identification number of the processor 109 to which a task can be allocated has been described above for ease of illustration, a table in which an identification number of each of processors and permission/inhibition of allocation (movement) are associated with each other may be retained as processor allocation information.

While an example in which the ROM 102 retains only the OS program 104 and the task program 105 has been described above for ease of illustration, the ROM 102 may retain a basic input/output system (BIOS) and a firmware for performing an initial setting at hardware level when the information processing apparatus 100 activated. The ROM 102 may be a mask ROM or a flash memory. In this case, in step S1201, the multiprocessor 101 may read a boot loader and initialize each of components of the information processing apparatus 100 at a hardware level at the time of startup (including initializing the processor core 111 and the FPU 110 and setting the FPU 110 to an invalid state) by processing of the BIOS or the firmware. In an incorporated OS, for example, the BIOS, the firmware, and the OS may constitute an integrated data structure, and a boundary between step S1201 and step S1202 may be unclear.

A second exemplary embodiment will be described.

In the second exemplary embodiment, the exceptional processing in the first exemplary embodiment is replaced with a system call. More specifically, a processor core 111 uses a system call for notifying of the start of use of an FPU 110 and a system call for notifying of the end of the use to detect the start or the end of the FPU 110. Components and steps having similar functions to those in the first exemplary embodiment are assigned the same reference numerals while description of components and steps that are not structurally or functionally different is omitted.

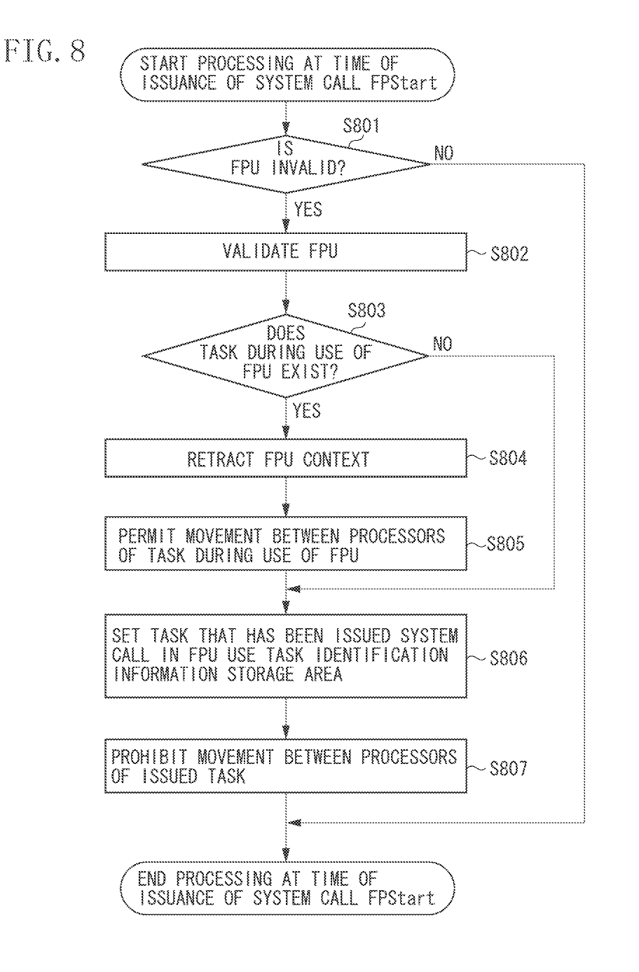

An operation of the present exemplary embodiment will be first described with reference to a flowchart illustrated in FIG. 8.

FIG. 8 is a flowchart illustrating an operation at the time of issuance of a system call FPStart for notifying of the start of use of the FPU 110 by a co processor context management function 205. In step S801, the co processor context management function 205 confirms whether the FPU 110 is invalid. If the FPU 110 is valid (NO in step S801), the processing ends. On the other hand, if the FPU 110 is invalid (YES in step S801), then in step S802, the co processor context management function 205 validates the FPU 110. In step S803, the co processor context management function 205 refers to an FPU use task identification information storage area, and confirms whether the task 202 during use of the FPU 110 exists.

If the task 202 during use of the FPU 110 exists (YES in step S803), then in step S804, the co processor context management function 205 retracts an FPU context for the task 202 to a task control block 106. In step S805, the co processor context management function 205 permits movement between processors of the task 202. Control of the movement between the processors is similar to that in the first exemplary embodiment, and hence details thereof are omitted. On the other hand, if the task 202 during use of the FPU 110 does not exist (NO in step S803), respective processes in step S804 and step S805 are not performed. In step S806, the co processor context management function 205 sets the task 202 that has issued the system call FPStart in the FPU use task identification information storage area. In step S807, the co processor context management function 205 prohibits movement between processors of the task 202 (issued task 202), and ends the processing at the time of issuance of the system call FPStart.

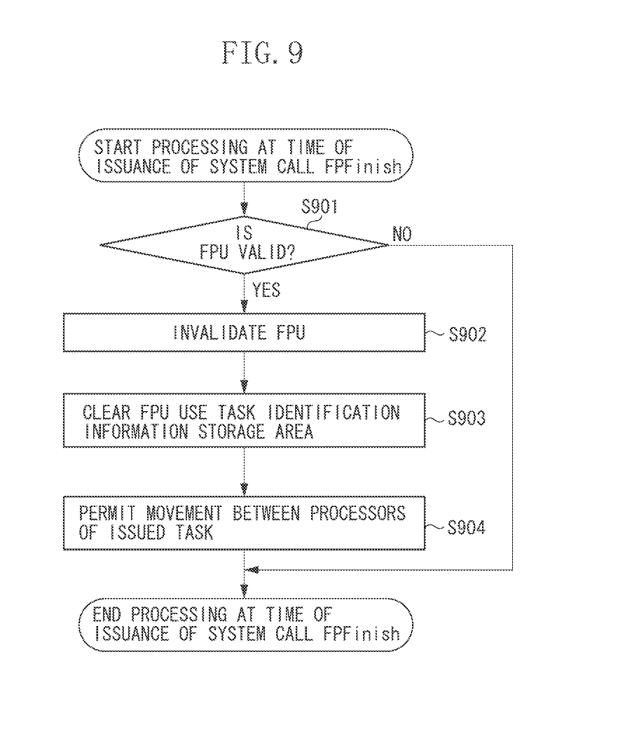

FIG. 9 is a flowchart illustrating an operation at the time of issuance of a system call FPFinish for notifying of the end of use of the FPU 110 by the co processor context management function 205. In step S901, the co processor context management function 205 confirms whether the FPU 110 is valid. If the FPU 110 is invalid (NO in step S901), the processing ends. On the other hand, if the FPU 110 is valid (YES in step S901), then in step S902, the co processor context management function 205 invalidates the FPU 110. In step S903, the co processor context management function 205 clears the FPU use task identification storage area. In step S904, the co processor context management function 205 permits movement between processors of the task 202 that has issued the system call FPFinish, and ends the processing at the time of issuance of the system call FPFinish.

An example of description of a task program using a system call in an OS in the second exemplary embodiment will be described with reference to a pseudo code illustrated in FIG. 10. In the task program, a floating-point operation range is surrounded by a system call “FPStart ( );” and a system call “FPFinish ( );” (the system calls are hereinafter merely referred to as FPStart and FPFinish, respectively). If the FPU 110 is used before a task issues the system call FPStart, an FPU exception is generated, and the processor core 111 validates the FPU 110. On the other hand, if the FPU 110 is used after the time point where it has issued the system call FPFinish, an FPU context may be destructed. Therefore, in the present exemplary embodiment, the task program is constructed so that the system call FPFinish is issued after reliable completion of the use of the FPU 110.

Scheduling in the first exemplary embodiment and scheduling in the second exemplary embodiment will be compared below, to describe handling of an FPU context in the second exemplary embodiment.

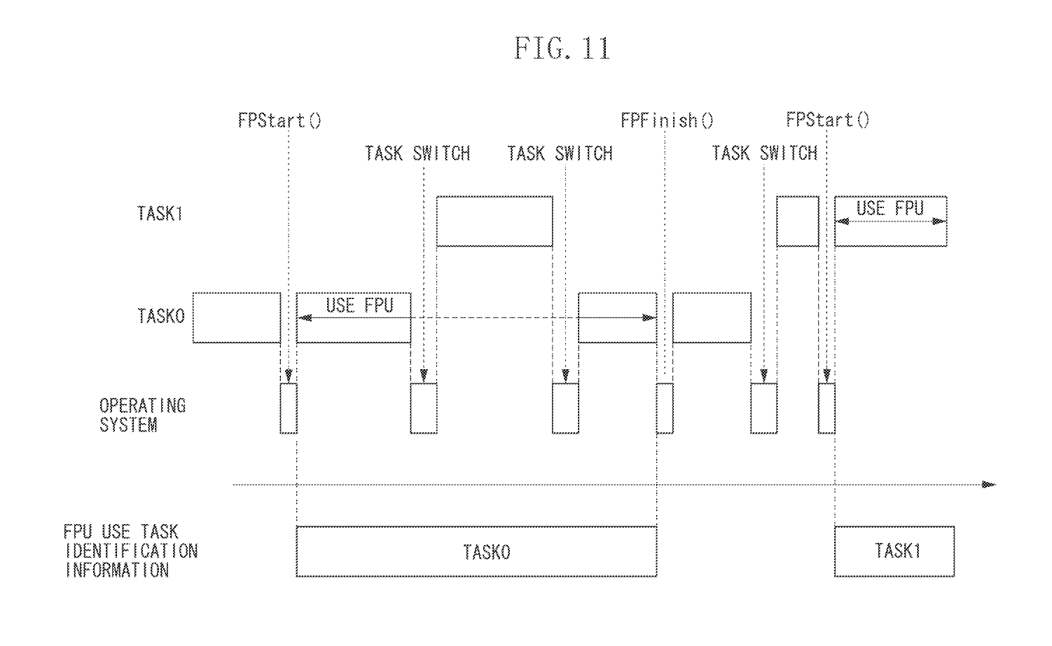

FIG. 11 illustrates an example in which an information processing apparatus according to the present exemplary embodiment schedules a similar task to that illustrated in FIG. 7. In FIG. 11, a system call FPStart is issued before a floating-point operation is performed. In the second exemplary embodiment, the start of use of a co processor is detected using the system call FPStart, and an FPU 110 is validated without an FPU exception being issued. The system call FPFinish is issued after a task 0 ends the floating-point operation. The end of use of the co processor is detected using the system call FPFinish. Thus, an FPU context is not transferred (retracted and restored) even after the third task switch is performed. Therefore, in the example illustrated in FIG. 11, data corresponding to the FPU context need not be transferred at all in management of the FPU context.

As described above, according to the second exemplary embodiment, the system call is embedded in a program, so that the number of times of transfer of the FPU context to be transferred for each task switch can be further reduced. Generally, in an incorporated OS, the system call is implemented as a function call, and an overhead can be more greatly reduced than that when exceptional processing is used. Further, the system call FPFinish reliably notifies that the FPU context need not be retracted. Therefore, the retraction of the FPU context, which has been required at the start of use of the FPU 110 immediately after the notification, need not be performed. A task for issuing the system call FPFinish is movable between the processors 109 at the time of issuance thereof. Therefore, a constraint in generation of a schedule as a system can be eliminated in a shorter time.

Other embodiments are described.

While an example in which the main context and the sub-context are retracted to the memory (RAM 103) according to the context switch has been described in the above-described exemplary embodiments, a shadow register set (also referred to as a background register) for retaining a context to be retracted into a processor 109 may be arranged.

A plurality of shadow register sets of equivalent sizes is desirably provided for each processor 109 for each of a register set 112 and a register set 113. If the shadow register sets are respectively of equivalent sizes, a context switch can be performed by switching in a hardware manner. For example, a selector physically switches the register set 112 (a regular register) and the shadow register set (a background register), so that a hard context switch can be performed without generating data transfer for retracting a context. To perform the hard context switch, a hard context switch command is interpreted for a multicore processor 101, to operate a selector, so that the regular register and the background register can be switched. A hard context switch itself is a function that has been mounted since early times in a processor such as Z80 (published in 1976) manufactured by ZILOG Corp., and details thereof is omitted.

While the processor core 111 is larger in die size than the FPU 110 in the above-described exemplary embodiment, the FPU 110 is not necessarily be smaller in die size in a configuration in which a plurality of cores and one co processor constitute one processor 109.

While the processes in the OS program 104 and steps S1202 to S1210 illustrated in FIG. 12 are performed in parallel in each of the processors 109 in the above-described exemplary embodiment, at least one of the processor cores 111 may perform processing for the other processor core 111. One or more processors for then executing a binary code of the OS program 104 may be selected and caused to perform processing according to respective loads of the plurality of processors 109, like in OSs in the Windows (registered trademark) system.

While a homogeneous multiprocessor in which all processors are equivalent to one another has been described as a typical example in the above-described exemplary embodiment, the present invention is also applicable to a heterogeneous multiprocessor in which only some processors include co processors. An effect of the present invention can be more significantly obtained in a heterogeneous multiprocessor in which at least two processors include equivalent co processors.

If the heterogeneous multiprocessor is targeted, one method is to describe whether a co processor is used in a task program and a processor allocation management apparatus allocates a processor including the co processor to a task using the co processor. Another method is, if a processor including no co processor is allocated to a task requiring a co processor at the time point where the start of use of the co processor is detected, to move the task to a processor including a co processor. According to these methods, the present invention is also applicable to the heterogeneous multiprocessor.

The movement of the co processor context is restricted in the above-described exemplary embodiment. However, in a simplistic form, for a multiprocessor 101 including a plurality of processors 109 each including a plurality of cores, a context of one of the cores can also be prevented from being moved to the other processor 109. The above-described effect can also be obtained by applying the present invention to a multiprocessor 101 including a plurality of processors 109 that set one of multicores prepared in a versatile manner as an FPU to use it.

While an example of a content of a register set included in each of a processor core and a co processor has been described in the above-described exemplary embodiment, a register set may include K M-bit registers (each of M and K need not be a power of 2).

A computer readable program code constituting a configuration of the above-described exemplary embodiment from an external storage device, a function expansion unit, or a storage medium, and a computer in a system or an apparatus may execute the program code.

An additional description will be made for the OS program 104 and the task program 105 in the above-described exemplary embodiment. The OS program 104 is generally provided by an OS providing maker, and also includes an updated difference (an updated portion provided by the maker). The task program 105 includes one that can be more freely installed and uninstalled than the OS program 104 after a user of the information processing apparatus 100 installs the OS program 104. The task program 105 may be preinstalled before a maker that manufactures the information processing apparatus 100 provides the information processing apparatus 100 to a user.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-224237 filed Oct. 9, 2012, which is hereby incorporated by reference herein in its entirety.

What is claimed is:

1. An information processing apparatus including a multiprocessor including a plurality of processors each including a first processing unit configured to process an allocated task based on a content of a first register, and a second processing unit configured to process the task based on a content of a second register, the information processing apparatus comprising:
a transfer unit configured to focus on one of the processors included in the multiprocessor, and to transfer, if a task to be allocated to the focused processor is changed, contents retained in a first register in the focused processor and a second register in the focused processor to a memory; and
a control unit configured to, in response to a start of processing a task allocated to the focused processor by a second processing unit in the focused processor, perform control to prohibit the transfer unit from transferring a content retained in a second register corresponding to the second processing unit to the memory.

2. An information processing apparatus configured to allocate a task to be executed to a processor core or a co processor in a multiprocessor including a plurality of processors each including the processor core and the co processor, the information processing apparatus comprising
a control unit configured to, upon detection of a start of processing of the task by the co processor, perform control to prohibit a co processor context used by the co processor from being transferred to a memory.

3. The information processing apparatus according to claim 2, wherein the control unit includes a start detection unit configured to detect the start of the processing of the task by the co processor after a task switch, and a restriction unit configured to restrict, if the start detection unit detects the start of the processing by the co processor, movement between the processors of the task that has started to be processed.

4. The information processing apparatus according to claim 2, further comprising a transfer unit configured to retract the co processor context of the second task to the memory if the co processor retains a co processor context for a second task when the co processor starts to process a first task.

5. The information processing apparatus according to claim 2, further comprising a transfer unit configured to restore the co processor context for the first task to a co processor for processing the first task from the memory if a co processor context for a first task exists in the memory when the co processor starts to process the first task.

6. The information processing apparatus according to claim 2, wherein the control unit causes the memory to retain, for each of the co processors, identification information of the task in which processing is started by the co processor.

7. The information processing apparatus according to claim 2, wherein the control unit is further configured to control the co processor so that a change of the task processed by the co processor is notified to the processor core.

8. The information processing apparatus according to claim 2, wherein the control unit is further configured to invalidate a co processor in a processor in which the task switch is performed when a task switch is performed and if a task that is being processed by the co processor and a task after the task switch differ from each other, and to controls the co processor to notify the processor core of an exception when a command to use the co processor has been issued after the task switch.

9. The information processing apparatus according to claim 2, wherein the control unit is further configured to detect the start of the processing by the co processor using a system call from a processor core that executes the task.

10. The information processing apparatus according to claim 2, wherein the control unit is further configured to cause the memory to retain the identification information of a processor to which the task can be allocated as processor allocation information and to change processor allocation information about a task whose movement is restricted so that only identification information of the processor including the co processor that is processing the task is retained in the processor allocation information.

11. The information processing apparatus according to claim 2, wherein the control unit includes an end detection unit configured to detect an end of processing of the task by the co processor and a permission unit configured to permit movement between the processors of the task in response to the detection by the end detection unit.

12. The information processing apparatus according to claim 2, wherein the control unit includes an end detection unit configured to detect an end of the processing of the task by the co processor, a permission unit configured to permit movement between the processors of the task in response to the detection by the end detection unit, and a clear unit configured to discard the co processor context retained in the memory for the task.

13. The information processing apparatus according to claim 12, wherein the clear unit is configured to clear identification information of the task that has been processed by a co processor, an end of the use of which has been detected by the end detection unit, from the memory.

14. The information processing apparatus according to claim 11, wherein the end detection unit is configured to detect an end of the processing of the task by the co processor as an end of the use of the co processor.

15. The information processing apparatus according to claim 11, wherein the end detection unit is configured to detect an end of processing of a task by the co processor using a system call from a processor core that executes the task.

16. The information processing apparatus according to claim 11, wherein the permission unit restores processor allocation information of a task that is permitted to move to a state where the movement of the task has not yet been restricted.

17. The information processing apparatus according to claim 2, wherein the co processor context includes a value to be retained in a register in the co processor, and movement of the task is processing for retracting a co processor context for the task to the memory and restoring the retracted co processor context to a register in a co processor in the other processor.

18. An information processing method by an information processing apparatus including a multiprocessor including a plurality of processors each including a first processing unit configured to process an allocated task based on a content of a first register, and a second processing unit configured to process the task based on a content of a second register, the information processing method comprising:
focusing on one of the processors included in the multiprocessor, and transferring respective contents retained in a first register in the focused processor and a second register in the focused processor to a memory if a task to be allocated to the focused processor is changed; and
performing control to prohibit the content retained in the second register corresponding to the second processing unit from being transferred to the memory in response to a start of processing a task allocated to the focused processor by a second processing unit in the focused processor.

19. An information processing method by an information processing apparatus configured to allocate a task to be executed to a processor core or a co processor in a multiprocessor including a plurality of processors each including the processor core and the co processor, the information processing method comprises
performing control to prohibit a co processor context used by the co processor from being transferred to a memory upon detection of a start of processing of the task by the co processor.
